(19) United States
(12) Patent Application Publication
(10) Pub. No.: US 2006/0234863 A1
(43) Pub. Date: Oct. 19, 2006

(54) Method for producing water-dispersible granules

(76) Inventors: Hans-Peter Krause, Hofheim (DE); Gerhard Schnabel, Frankfurt (DE); Roland Deckwer, Frankfurt (DE); Detlev Haase, Frankfurt (DE); Thomas Polednie, Hochheim (DE); Dieter Reinig, Bensheim (DE)

Correspondence Address: CONNOLLY BOVE LODGE & HUTZ, LLP, P O BOX 2207, WILMINGTON, DE, 19899, US

(21) Appl. No.: 10/546,430

(22) PCT Filed: Feb. 11, 2004
(86) PCT No.: PCT/EP04/01255

§ 371 Date: Feb. 21, 2006

(30) Foreign Application Priority Data
Feb. 19, 2003 (DE) 103 07 078.8

(51) Int. Cl. A01N 43/00; A01N 25/12

(52) U.S. Cl. 504/129; 504/367

(57) ABSTRACT

The present invention relates to a method for producing water-dispersible plant protection agent granules comprising, as steps, A. spraying two or more separate fluid streams in an agglomeration device, where a) at least one of the fluid streams comprises one or more agrochemical active ingredients with a melting point of 120° C. or above, and b) at least one of the fluid streams comprises one or more agrochemical active ingredients with a melting point of less than 120° C. and one or more carriers, and B. agglomeration.

The present invention relates to the field of the plant protection agent formulations. In particular, the invention relates to a method for producing water-dispersible plant protection agent granules (WG).

Active ingredients for plant protection are generally not employed in pure form. Depending on the field and type of application and on physical, chemical and biological parameters, the active ingredient is employed as active ingredient formulation in combination with conventional adjuvants and additives. The combinations with further active ingredients, for example for extending the spectrum of action and/or protecting the crop plants (for example by means of safeners) are also known. Advantages are for example simpler handling, reduced risk of applying incorrect dosages and reduced production costs.

If the combinations are applied as granules, undesired contact effects may result, for example in those cases where liquid components or low-melting components are present together with high-melting components. This may result in the formation of aggregations or lumps which make handling, measuring and metering more difficult. Moreover, in those cases where the formulations are combinations which are insoluble in water and where rapid and homogeneous dispersibility in the spray tank is critical, sedimentations may form on the bottom of the container and before the main filters or the nozzle filters.

Tank-mix methods avoid the abovementioned disadvantages as they may occur when liquid components or low-melting components come into contact with high-melting components.

As is known, the handling of separate pack units, with separate metering and disposal of emptied containers, is, however, disadvantageous in comparison with combination products. While these problems are largely avoided by what are known as twin-pack solutions, such solutions cause additional complexities regarding development, production and quality assurance. It has therefore been attempted to produce combination products.

Thus, WO 97/20467 describes the use of highly disperse silica as absorptive matrix for liquid phases for the purposes of protection against contact with ethoxysulfuron. In this case, the final product is found by extruding a moistened mixture of all components. The disadvantage in this concept is that, when the moist premix passes through the extrusion tool (for example screen), pressure builds up, whereby the absorbed liquid or semi-plastic mixture is squeezed out of the support material, resulting in undesired irreversible bridge formation within the particulate phase. The consequence for the product are then reduced suspendability in water and unacceptable filter residues in agricultural application devices.

Another method of producing products in granule form is fluidized-bed granulation (fluidized-bed agglomeration), where less pressure acts on the material to be granulated (EP-A-0757891, EP-A-611 593, EP-A-821 618, U.S. Pat. No. 5,883,047). Thus, WO 98/42192 describes a method for producing agrochemical products in which sulfonylureas and low-melting adjuvants are formulated with highly dispersed calcium silicate as a joint slurry and are granulated as a fluidized-bed layer by means of a two-substance nozzle method. The disadvantage of this concept is that, again, the various compartments interact unfavorably with one another since they are processed in a joint emulsion and/or suspension. Here, the low-melting component can be emulsified, or washed, out of its porous support and come into contact with the particulate component, which leads to the known disadvantages.

The present invention aimed at providing an improved method for producing water-dispersible plant protection agent granules with mixtures of high- and low-melting agrochemical active ingredients. Surprisingly, it has been found that this aim can be achieved by the method of the present invention.

Thus, the present invention relates to a method for producing water-dispersible plant protection agent granules comprising, as steps,
A. spraying two or more separate fluid streams in an agglomeration device, where
   a) at least one of the fluid streams comprises one or more agrochemical active ingredients with a melting point of 120° C. or above, and
   b) at least one of the fluid streams comprises one or more agrochemical active ingredients with a melting point of less than 120° C. and one or more carriers, and
B. agglomeration.

The term plant protection agent granules is understood as meaning granules comprising agrochemical active ingredients. Granules, their preparation and the devices used for this purpose are described, for example, in H. Mollet, A. Grubenmann, Formulierungstechnik [Formulation technology], Verlag Wiley—VCH, 2000, whose chapter 6.2 is herewith incorporated into the description. Particularly suitable granules for the purposes of the present invention is bulk material with a particle diameter of 50 to 10 000, preferably 100 to 1000, especially preferably 200 to 900 micrometers, measured by dry-sieve analysis. Methods for determining the quality of granules are described, for example, in CIPAC Handbook, Vol. F, Publisher: Collaborative International Pesticides Analytical Council Ltd. (1995). Water-dispersible plant protection agent granules are described, for example, in H. Mollet, A. Grubenmann, Formulierungstechnik, Verlag Wiley—VCH, 2000, chapter 14.2.3, which is herewith incorporated into the description.

In the method according to the invention, two or more separate fluid streams are sprayed jointly in an agglomeration device. The fluid streams preferably have room temperature during the spraying process and are generally sprayed at a pressure of 2-10 bar, preferably 4-6 bar.

Spraying can be effected, for example by means of two or more two-substance nozzles, or by means of one or more three- or multi-substance nozzles.

A two-substance nozzle is constructed in such a way that a fluid stream which constitutes the phase to be sprayed is, at the nozzle exit, surrounded by an enveloping flow of a stream of gas (for example air or nitrogen) which is conducted concentrically to the fluid stream and, upon exiting the nozzle, dispersed into fine spray droplets (see, for example, H. Mollet, A. Grubenmann, Formulierungstechnik, Verlag Wiley—VCH, 2000, page 219).

A three- or multi-substance nozzle is constructed in such a way that two or more separate fluid streams, which constitute the phases to be sprayed, are, at the nozzle exit, surrounded by an enveloping flow of one or more streams of gas (for example air or nitrogen) which are conducted concentrically to one or more of the fluid streams and, upon exiting the nozzle, dispersed into fine spray droplets (see, for example, EP-A-611 593).

In a preferred embodiment, two different fluid streams—fluid stream a) and fluid stream b)—are sprayed. Here, the fluid streams a) and b) can be sprayed for example by means of two separate two-substance nozzles, viz. the fluid stream a) by means of a two-substance nozzle α) and the fluid stream b) by means of a two-substance nozzle β). In a preferred embodiment, the two fluid streams a) and b) are sprayed jointly by means of a three-substance nozzle.

To optimize the conduct of the process, it is also possible to use a plurality of identical pairs of two-substance nozzles α), β) or a plurality of identical three- or multi-substance nozzles for the spraying procedure in the agglomeration device.

Agglomeration devices into which the fluid streams can be sprayed are known to the skilled worker (see, for example, H. Mollet, A. Grubenmann, Formulierungstechnik, Verlag Wiley—VCH, 2000, chapters 6.2.5, 6.2.7 and 6.2.8). Examples of such agglomeration devices are described, for example, in EP-A-0757891, EP-A-611 593, EP-A-821 618, U.S. Pat. No. 5,883,047 and WO 98/42192.

A variety of agglomeration methods known to the skilled worker may be used to carry out the agglomeration (see, for example, H. Mollet, A. Grubenmann, Formulierungstechnik, Verlag Wiley—VCH, 2000, chapters 6.2.5, 6.2.7 and 6.2.8), some of which are described hereinbelow by way of example.

Thus, agglomeration may be performed for example by means of spray drying, where the fluid streams a) and b) are sprayed by means of two or more two-substance nozzles or by means of one or more three- or multi-substance nozzles into a sufficiently long, vertical fall zone. The resulting droplets dry off during falling—preferably by using a warm process gas stream (for example air or nitrogen)—and agglomerate and arrive at the bottom of the apparatus as fine granules. Equipment for this purpose is produced for example by Niro, for example the type Niro Atomizer.

A preferred embodiment is fluidized-bed agglomeration, where the fluid streams a) and b) are sprayed by means of two or more two-substance nozzles or by means of one or more three- or multi-substance nozzles into a chamber (agglomeration chamber) which is initially preferably empty and has a continuous warm process gas stream (for example air or nitrogen) passing through it against the force of gravity. Owing to the process gas stream, the resulting droplets dry off and are kept in a permanent floating state (fluidized bed). The fine granules which are the primary result of the first volume fractions of the fluid streams remain in the fluidized bed and act as core for the formation of larger granule particles as the result of droplets from the subsequent volume fractions of the fluid streams settling on them and drying off (agglomeration). Granule particles with sizes up to the millimeter range can thus be obtained. Equipment for fluidized-bed agglomeration are produced for example by Aeromatic, for example the type MP-1 for the purposes of technical laboratories.

The method according to the invention can be carried out continuously or batchwise. The fluid streams a) and b) sprayed in the method according to the invention comprise, in addition to the agrochemical active ingredients, water as the continuous phase. Further components, for example solvents or adjuvants and additives conventionally used in plant protection, such as fertilizers (for example Nitrophoska® by BASF) or formulation auxiliaries such as antidrift agents, humectants, surfactants such as betaine-type or polymeric surfactants, dispersants, wetters, emulsifiers, stabilizers such as pH stabilizers, UV stabilizers, antifoams, synthetic or natural polymers, or potentiators such as Genapol series (for example Genapol X-100) may optionally be present.

To prepare the fluids a) and b), the components can be mixed with one another by known methods, for example by stirring or by jointly milling all or some of the components.

Suitable agrochemical active ingredients for the purposes of the present invention are, for example, herbicides, fungicides (for example fluquinconazole, propiconazole), insecticides (for example deltamethrin, cypermethrin), safeners or plant growth regulators (for example thidiazurone). The agrochemical active ingredients mentioned in the present description are generally known, for example known from “The Pesticide Manual” British Crop Protection Council, Editor: CDS Tomlin. The melting points of the agrochemical active ingredients are measured by means of differential thermoanalysis.

If agrochemical active ingredients are mentioned in the present application, they are always understood as meaning not only the neutral compounds, but also their salts with inorganic and/or organic counterions. Thus, for example, sulfonylureas may form for example salts in which the hydrogen of the —SO₂—NH group is replaced by an agriculturally useful cation. These salts are for example metal salts, in particular alkali metal salts or alkaline earth metal salts, in particular sodium salts or potassium salts, or else ammonium salts, or salts with organic amines. Likewise, salt formation may take place by attachment of an acid to basic groups such as, for example, amino and alkylamino. Acids which are suitable for this purpose are strong inorganic and organic acids, for example HCl, HBr, H₂SO₄ or HNO₃.

Fluid stream a) comprises one or more agrochemical active ingredients with a melting point of greater than 120° C. In a preferred embodiment, suitable agrochemical active ingredients with a melting point of greater than 120° C. are herbicides such as (the melting points are given in parentheses): sulfonylureas, such as foramsulfuron (199° C.) and its salts, such as the sodium salt, mesosulfuron and its salts and esters, such as mesosulfuron-methyl and its salts, for example mesosulfuron-methyl-sodium (189° C.), iodosulfuron and its salts and esters, such as iodosulfuron-methyl and its salts, for example iodosulfuron-methyl-sodium (152° C.), ethoxysulfuron (144° C.) and amidosulfuron (160° C.), propoxycarbazone (230° C.), bromoxynil-phenol (194° C.), bromoxynil-potassium (360° C.), ioxynil-phenol (212° C.), ioxynil-sodium (360° C.), diflufenican (159° C.), 2,4-D acid (141° C.), 2,4-D sodium, isoxaflutole (140° C.), sulcotrione (139° C.), glyphosate (189° C.), glufosinate-ammonium (215° C.), phenmedipham (143° C.), desmedipham (120° C.), metamitron (167° C.) and oxadiargyl (131° C.).

The fluid stream a) preferably comprises at least one agrochemical active ingredient such as a herbicide which has a melting point of 120° C. or above and is sparingly soluble in water, for example less than 1000 mg/l, preferably less than 100 mg/l, especially preferably less than 10 mg/l, measured under standard conditions. In a preferred embodiment, these agrochemical active ingredients which have a high melting point and are sparingly soluble in water are employed in a form in which they are ground finely to a defined size, the particle size generally being 1-20 micrometers, preferably 2-10 micrometers, especially preferably 3-8 micrometers, measured by dry-sieve analysis.

Fluid stream a) furthermore comprises water and, optionally, further components such as adjuvants and additives conventionally used in plant protection, in particular dispersants, antifoams and wetters; carriers may likewise be present.

Fluid stream b) comprises one or more agrochemical active ingredients with a melting point of less than 120° C., preferably 90° C. or less. These agrochemical active ingredients may also be employed in dissolved form.

In a preferred embodiment, suitable agrochemical active ingredients with a melting point of less than 120° C. are herbicides and safeners such as (the melting points are shown in parentheses):

mefenpyr-diethyl (50° C.), isoxadifen-ethyl (86° C.), bromoxynil-octanoate (45° C.), ioxynil-octanoate (59° C.), MCPA 2-ethylhexyl, Fenoxaprop-P-ethyl (89° C.), diclofop-methyl (118° C.), bromoxynil-butyrate (90° C.), ethofumesate (70° C.) and oxadiazone (87° C.).

The carriers present in fluid stream b) and optionally also in fluid stream a) are solids. These are generally known, for example from: W. van Falkenburg (Ed.), Pesticide Formulations, Marcel Dekker, Inc., New York, 1973; or from: Schriftenreihe Degussa No. 1, Synthetische Kieselsäuren für Pflanzenschutz- und Schädlingsbekämpfungsmittel [Synthetic silicas for plant protection compositions and pesticides], March 1989. They are also commercially available.

Preferred carriers are, for example, inorganic or organic carriers such as cellulose and its derivatives, for example Tylose®, Tylopur®, Methylan® and Finnix®, starch and its derivatives, for example Maizena® and Mondamin®, or silicates such as kaolin, bentonite, talc, pyrophyllite, diatomaceous earth and precipitated silicas, for example Sipernat® (for example Sipernat® 50 S or Sipernat® 500 LS), Dessalon®, Aerosil®, Silkasil® or Ketiensil®.

Fluid stream b) furthermore comprises water. Other components such as organic solvents, for example saturated or unsaturated aliphatic solvents (for example white oil), aromatic solvents (for example Solvesso® 100, Solvesso® 150 or Solvesso® 200 or xylene), vegetable oils and their transesterification products (for example rapeseed oil and rapeseed oil methyl ester) or esters of aliphatic carboxylic acids (for example Rhodiasolv®RDPE) or of aromatic carboxylic acids (for example benzyl benzoate) and adjuvants and additives conventionally used in crop protection, such as emulsifiers, may optionally also be present.

The present invention furthermore relates to water-dispersible plant protection agent granules obtainable by the method of the present invention. These granules have outstanding performance characteristics such as disintegratability in the spray tank, stability of the spray mixture and the ability to pass through filters.

Preferred granules according to the invention comprise the following combinations of two or more agrochemical active ingredients: diflufenican+mefenpyr-diethyl, iodosulfuron-methyl-sodium+diflufenican+mefenpyr-diethyl, mesosulfuron-methyl+iodosulfuron-methyl-sodium+diflufenican+mefenpyr-diethyl, mesosulfuron-methyl-sodium+iodosulfuron-methyl-sodium+diflufenican+mefenpyr-diethyl, iodosulfuron-methyl-sodium+mefenpyr-diethyl+bromoxynil-octanoate or iodosulfuron-methyl-sodium+mefenpyr-diethyl+bromoxynil-butyrate.

The technical examples which follow are intended to illustrate the invention and have no limiting character whatsoever.

### A. EXAMPLE

1. Preparation of the Fluids

Fluid a)

1082 g of diflufenican, 640 g of kaolin, 363 g of Morwet® D 425, 98 g of Hostapur® OSB, 63 g of Kuviskol® K30 and 6 g of antifoam powder ASP®13 were introduced into 4.7 l of water, with stirring. The slurry was milled in a ball mill, type Dyno-Mill KDL Pilot (d40 4 μm). 69 g of mesosulfuron-methyl-sodium and 23 g of iodosulfuron-methyl-sodium were subsequently stirred into the resulting dispersion.

Fluid b)

151 g of Sipernat® 50S were made into a slurry with 1.2 l of water, and the solution of 202 g of mefenpyr-diethyl, 19 g of dispersant Emulsogen®3510 and 14 g of Phenylsulfonat®Ca in 209 g of Solvesso®200ND was introduced, with stirring. Thereafter, the mixture was stirred for 30 minutes at room temperature.

2. Fluidized-bed Agglomeration

The two fluids a) and b) were sprayed by means of a three-substance nozzle in an Aeromatic MP1 fluidized-bed agglomeration plant. Fluid a) was sprayed at 9.6 l/h, corresponding to 4690 g of load/h, while fluid b) was sprayed at 2.4 l/h, corresponding to 1190 g of load/h. The amount of process gas was 50 m³/h, at a gas inlet temperature of 135° C., and the product temperature was 50° C. This yielded 2.5 kg of flowable granules. The performance characteristics were checked in accordance with CIPAC methods (CIPAC Handbook, Vol. F., Editor: Collaborative International Pesticides Analytical Council Ltd. (1995)) and gave the following results: dispersibility (CIPAC MT174): 87%, suspendability (CIPAC MT161): 85%, wet-sieving test (CIPAC MT59): 0.24% residue on 150 μm.

### B. COMPARATIVE EXAMPLE

A premix consisting of 793.8 g of diflufenican, 50.8 g of mesosulfuron-methyl-sodium, 16.7 g of iodosulfuron-methyl-sodium, 470 g of kaolin, 266 g of Morwet® D 425, 71.7 g of Hostapur® OSB, 46.2 g of Luviskol® K30 and 4.6 g of antifoam powder ASP®13, and the absorbate of a solution of 148.3 g of mefenpyr-diethyl, 13.9 g of dispersant Emulsogen®3510 and 10.1 g of Phenylsulfonat®Ca in 154 g of Solvesso®200 on 111 g of Sipernat® 50S were introduced into 4.3 l of water, with stirring, and milled finely in a ball mill, type Dyno-Mill KDL Pilot (d50=4 μm). The resulting slurry was sprayed by means of a two-substance nozzle in a fluidized-bed agglomeration plant (Aeromatic MP1). An amount of process gas of 42 m³/h and 8 kg of spray liquid/h, a gas inlet temperature of 140° C. and a product temperature of 55° C. produced 2.4 kg of flowable granules. The results of the performance characteristic checks by CIPAC methods were: dispersibility (CIPAC MT174): 42%, suspendability (CIPAC MT161): 30%, wet-sieving test (CIPAC MT59): 12% residue on 150 μm.

1. A method for producing water-dispersible plant protection agent granules comprising, as steps,
A. spraying two or more separate fluid streams in an agglomeration device, where
a) at least one of the fluid streams comprises one or more agrochemical active ingredients with a melting point of 120° C. or above, and
b) at least one of the fluid streams comprises one or more agrochemical active ingredients with a melting point of less than 120° C. and one or more carriers, and
B. agglomeration.

2. The method as claimed in claim 1, wherein the fluid streams are sprayed by means of one or more two-substance nozzles or by means of one or more three- or multi-substance nozzles.

3. The method as claimed in claim 1, wherein two different fluid streams are sprayed.

4. The method as claimed in claim 1, wherein the agglomeration device is a spray-drying device or a fluidized-bed agglomeration device.

5. The method as claimed in claim 1, wherein fluid streams a) and b) comprise water.

6. The method as claimed in claim 1, wherein the fluid stream a) comprises, as agrochemical active ingredients, one or more herbicides.

7. The method as claimed in claim 1, wherein the fluid stream b) comprises, as agrochemical active ingredients, one or more herbicides and/or one or more safeners.

8. Water-dispersible plant protection agent granules, produced by the method as claimed in claim 1.

9. Water-dispersible plant protection agent granules as claimed in claim 8, comprising a) one or more agrochemical active ingredients with a melting point of 120° C. or above, b) one or more agrochemical active ingredients with a melting point of less than 120° C. and c) one or more carriers.

10. Water-dispersible plant protection agent granules as claimed in claim 8, comprising a), as agrochemical active ingredients with a melting point of 120° C. or above, one or more herbicides, and b), as agrochemical active ingredients with a melting point of less than 120° C., one or more herbicides and/or one or more safeners.

11. Water-dispersible plant protection agent granules as claimed in claim 8, comprising, as agrochemical active ingredients, diflufenican+mefenpyr-diethyl, iodosulfuron-methyl-sodium+diflufenican+mefenpyr-diethyl, mesosulfuron-methyl+iodosulftiron-methyl-sodium+diflufenican+mefenpyr-diethyl, mesosulfuron-methyl-sodium+iodosulfuron-methyl-sodium+diflufenican+mefenpyr-diethyl, iodosulfuron-methyl-sodium+mefenpyr-diethyl+bromoxynil-octanoate or iodosulfuron-methyl-sodium+mefenpyr-diethyl+bromoxynil-butyrate.
